(19) United States
(12) Patent Application Publication
(10) Pub. No.: US 2007/0100502 A1
(43) Pub. Date: May 3, 2007

(54) Systems and methods to control a multiple-fuel steam production system

(76) Inventors: John Duncan Rennie JR., Honey Brook, PA (US); Chris Lawrence Nowack, Cumming, GA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/262,271

(22) Filed: Oct. 27, 2005

(51) Int. Cl. G05B 21/00

(52) U.S. Cl. 700/266

(57) ABSTRACT

Systems, methods, and articles of manufacture to control a multiple-fuel steam production system are disclosed. An example method obtains a plurality of input values associated with producing steam and uses a model predictive controller to determine a first value associated with predicting an amount of a first fuel and a second value associated with predicting an amount of a second fuel to produce an amount of steam. Fuel feed rates of the first and second fuels are then controlled based on the first and second trajectory values.

### FIELD OF THE DISCLOSURE

The present disclosure relates generally to processor control systems and, more particularly, to process control systems and methods to control a multiple-fuel steam production system.

### BACKGROUND

Process systems, like those used in paper production or other manufacturing processes, often use steam production processes to generate steam for powering various sub-systems and for on-site generation of electricity. To produce steam, a steam production process system is provided with an energy source such as a combustible fuel. Single fuel steam production systems are typically powered using refined oil or natural gas. To reduce the costs associated with fuel, companies have implemented multiple-fuel powered steam production systems. A multiple-fuel (i.e., multi-fuel) steam production system provides cost effective steam production by burning fossil fuels (e.g., gas, oil, coal, etc.) in addition to alternative, lower-cost fuels such as, for example, waste wood and shredded tires. By balancing the supply rate, feed rate, flow rate, etc. of a fossil fuel and a lower-cost fuel, a multi-fuel steam production system can operate at a relatively lower cost by relying relatively more on the lower-cost fuel than the more expensive fossil fuel whenever possible while maintaining required steam output.

Maintaining the appropriate balance between fuels in a multi-fuel steam production system often poses a challenge due to the varying energy content, concentrations, or output associated with each fuel type. For example, while refined fossil fuels typically provide a constant energy content per volume (e.g., an amount of energy per volume measured in, for example, joules or British Thermal Units (BTU's)), the amount of energy per volume in lower-cost fuels such as waste wood or shredded tires (or other waste material) varies within each batch and from batch to batch as the alternative lower-cost fuel is supplied or fed to the steam production system.

Steam output can become non-compliant or fall out of a desired or required operating range when energy content per volume changes within a batch or between batches of alternative fuel. For instance, settings (e.g., fuel ratios) of a steam production system may be set according to a particular energy content of a previously supplied alternative fuel (e.g., a previous batch of waste wood) when a subsequent supply of alternative fuel having a different energy content is supplied. In this case, if the change in energy content per volume in the alternative fuel decreases, the amount of produced steam decreases, thus requiring an increase in the amount of refined fossil fuel needed to compensate for the decreased energy content in the alternative fuel.

To compensate for the varying levels of energy content per volume of alternative, lower-cost fuels, some traditional steam production systems require a skilled operator to monitor various aspects of the steam production process to ensure that an appropriate balance is maintained between the amount of refined fossil fuel supplied and the amount of alternative fuel supplied to maintain steam production within an acceptable operating range. These traditional systems require that an operator constantly observe measurement gauges and alarms and make adjustments to fuel supply ratios in response to non-compliant gauge readings or alarms indicative of an inappropriate balance between the fossil fuel supply and the alternative fuel supply. Traditional steam production systems controlled manually by a skilled operator are often inefficient due to the limited knowledge or skill of the operators, the response times of operators, and the operators'interpretations of measurement gauges and alarms. Further, the efficiencies and fuel consumption of these traditional systems are typically non-deterministic because operator responses can vary over time and between operators.

To automate the procedure of maintaining balance (e.g., fuel ratios) between fossil fuels and alternative fuels, other traditional steam production systems use one or more proportional-integral-derivative (PID) controllers that monitor steam production quantities to dynamically determine steam output and automatically adjust fuel ratio settings. However, these traditional systems use measurements of present operation to adjust fuel ratios in a reactive or lagging manner such that inefficiencies result between the time at which steam production output is recognized as being non-compliant (e.g., outside of a target operating range), the time at which the PID controller detects the non compliancy of the steam production, and the time at which the PID controller adjusts of the fuel ratio to correct the non-compliant steam production output.

The inefficiencies associated with known manually controlled and PID-controlled steam production systems can lead to higher operating costs because excessive amounts of relatively higher-cost fossil fuels are used. These known systems can also result in lower manufacturing product yields (e.g., paper production yields) when steam production outputs fall below minimal threshold levels due to inappropriate fuel ratios.

### SUMMARY

Example systems and methods to control a multiple-fuel steam production system are disclosed. An example method involves obtaining a plurality of input values associated with producing steam and using a model predictive controller to determine a first value associated with predicting an amount of first fuel and a second value associated with predicting an amount of second fuel to produce an amount of steam. Fuel feed rates of the first and second fuels are then controlled based on the first and second values.

In accordance with another example, an example system includes a model predictive controller to determine a first value associated with predicting an amount of a first fuel and a second value associated with predicting an amount of a second fuel to produce an amount of steam. The example system also includes first and second fuel feeder controls to control fuel feed rates of the first and second fuels based on the first and second values.

In accordance with another example, an example machine accessible medium includes instructions stored thereon that, when executed, cause a machine to determine a first value associated with predicting an amount of a first fuel and a second value associated with predicting an amount of a second fuel to produce an amount of steam. Additionally, the instructions cause the machine to control fuel feed rates of the first and second fuels based on the first and second values.

### BRIEF DESCRIPTION OF THE DRAWINGS

FIG. 1 depicts an example multi-fuel steam production process system.

FIG. 2 is a detailed block diagram of the example control system of FIG. 1 that may be used to implement the example systems and methods described herein.

FIG. 3 is a flow diagram that depicts an example method that may be used to control the example steam production system of FIG. 1.

FIG. 4 is a flow diagram depicting an example method that may be used to determine predicted trajectory adjustment output values associated with fuel supply rates to a boiler furnace.

FIG. 5 is a flow diagram of an example method that may be used to determine energy compensation values associated with adjusting fuel feed rates in the example steam production system of FIG. 1 in response to varying fuel energy content.

FIG. 6 is a flow diagram of an example method that may be used to determine required amounts of fuel to operate the example steam production system of FIG. 1 within specified operating conditions.

FIG. 7 is a flow diagram of an example method that may be used to determine and control the required airflows of the example steam production system of FIG. 1.

FIG. 8 is a block diagram of an example processor system that may be used to implement the example systems, methods, and articles of manufacture described herein.

### DETAILED DESCRIPTION

Although the following discloses example systems including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example systems, persons of ordinary skill in the art will readily appreciate that the examples provided are not the only way to implement such systems.

In contrast to some known multiple-fuel powered steam production systems that use proportional-integral-derivative (PID) controllers to automatically control the fuel ratios used to supply or feed different fuels to steam boilers using reaction-driven techniques, the example systems, methods, and articles of manufacture described herein may be used to automatically control fuel ratios using predictive analyses and control. In some known multiple-fuel powered steam production systems, automatic process controllers analyze measurement of current operating conditions and react to those operating conditions by, for example, adjusting fuel ratios only when the operating conditions have approached or exceeded a compliant operating condition. Known systems typically use PID feedback loops that can only react to a present or current state of operation. As a result, these known systems often fall into non-compliant operating states before any automatic correction adjustment is made or effective. Thus, known steam production systems often operate inefficiently due to the delay between the time at which the system starts operating in a non-compliant condition and the time at which a process controller detects the condition and reacts by making corrective adjustments.

In contrast to the above-noted known systems, the example systems and methods described herein use predictive techniques to determine the manner in which a steam production system should be controlled to substantially reduce or prevent instances in which (or the time during which) the steam production system operates outside of certain operating thresholds or ranges, thus increasing the efficiency of the steam production system. An example implementation uses a model predictive controller and fuzzy logic to monitor and process various measurement data (e.g., energy content of fuel(s), fuel feed rate(s), steam flow, steam pressure, fuel cost(s), etc.) associated with the steam production system to determine forward-looking or predicted control parameters that should be used to configure the steam production system to maintain efficient and compliant operation.

In some example implementations, efficient operation involves maintaining a desired steam production output by relying more on alternative lower-cost fuels (e.g., waste wood, shredded tires, etc.) than on relatively more expensive fossil fuels (e.g., coal, gas, oil, etc.). Multi-fuel steam production systems can become inefficient when a fossil fuel-to-alternative fuel ratio is higher than necessary. Compliant operation typically involves outputting an amount of steam that is within a desired or a required operating range (e.g., an amount of steam output required to run other manufacturing subsystems or to generate a desired amount of electricity via steam-powered turbines) so that other sub-systems of a manufacturing site can receive the required steam power (or electric power) to operate or operate efficiently.

As described in greater detail below, the example systems and methods use model predictive controllers and fuzzy logic in multi-fuel steam production systems to determine fuel supply ratios associated with alternative, lower-cost fuels having varying energy content per volume and fossil fuels to produce a desired or required amount of steam production output, while maintaining relatively low operating costs. Because the price of oil fluctuates continuously, the price of oil is a factor that the example methods and systems described herein can use to determine fuel supply ratios such that a steam production system produces a desired or required amount of steam, yet operates within prescribed budgetary constraints.

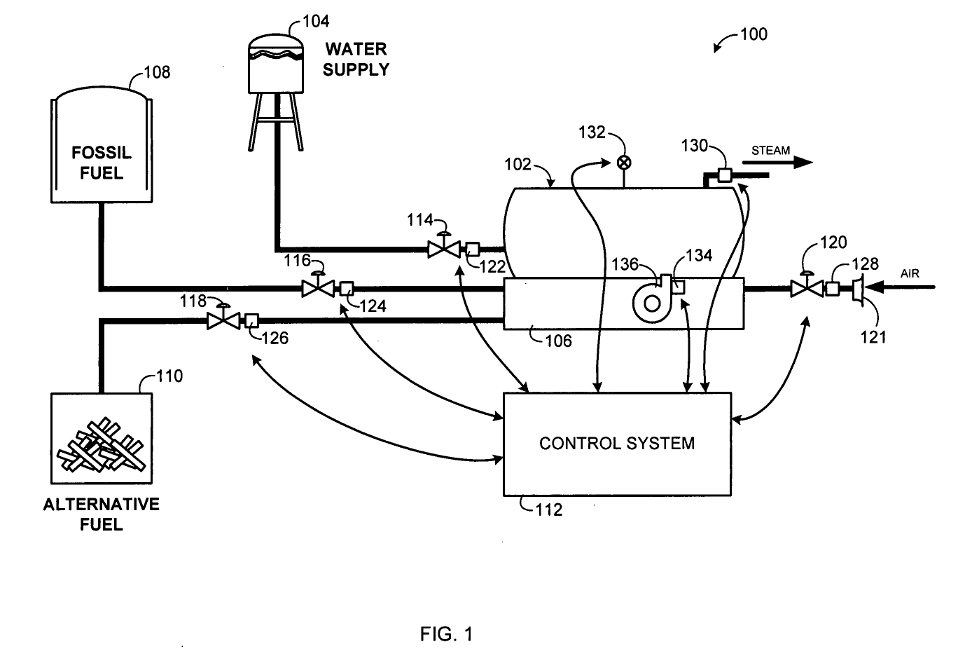

FIG. 1 is a diagram representative of an example steam production process system 100. The example steam production system 100 is a multi-fuel system that may be implemented at a manufacturing site (e.g., a paper mill) to produce steam used for operating various manufacturing sub-systems, and/or to produce on-site electricity (e.g., via steam turbines), and/or for any other purpose. The example systems and methods are described herein as being advantageously applicable to controlling a steam production system (e.g., the example steam production system 100) that burns different fuel types, at least one of which may be associated with a varying energy content characteristic (e.g., varying BTU per volume). In particular, the example steam production system 100 is described below as using a fossil fuel and an alternative lower-cost fuel. However, in alternative implementations, the example systems and methods described herein may be used to control steam production systems that use any other combination of two or more fuel types. For example, the example systems and methods described herein may be used to control a steam production system that uses a first fuel type having particular characteristics (e.g., cost characteristics, energy content characteristics, byproduct characteristics, etc.) and a second fuel type having different characteristics (e.g., a different cost, a different energy content, different byproducts, etc.) than the first fuel type.

As shown in FIG. 1, the example steam production system 100 includes a steam boiler 102 that receives water from a water supply 104. The steam boiler 102 includes a furnace 106 that burns multiple fuel types to produce steam. In particular, the furnace 106 receives a fossil fuel (e.g., a first fuel) from a fossil fuel supply reservoir 108 (e.g., a first fuel type supply reservoir) and an alternative fuel (e.g., a second fuel) from an alternative fuel supply reservoir 110 (e.g., a second fuel type supply reservoir). The fossil fuel may be, for example, coal, oil, gas, etc., and the alternative fuel may be a lower-cost fuel such as, for example, wood waste, shredded tires, etc.

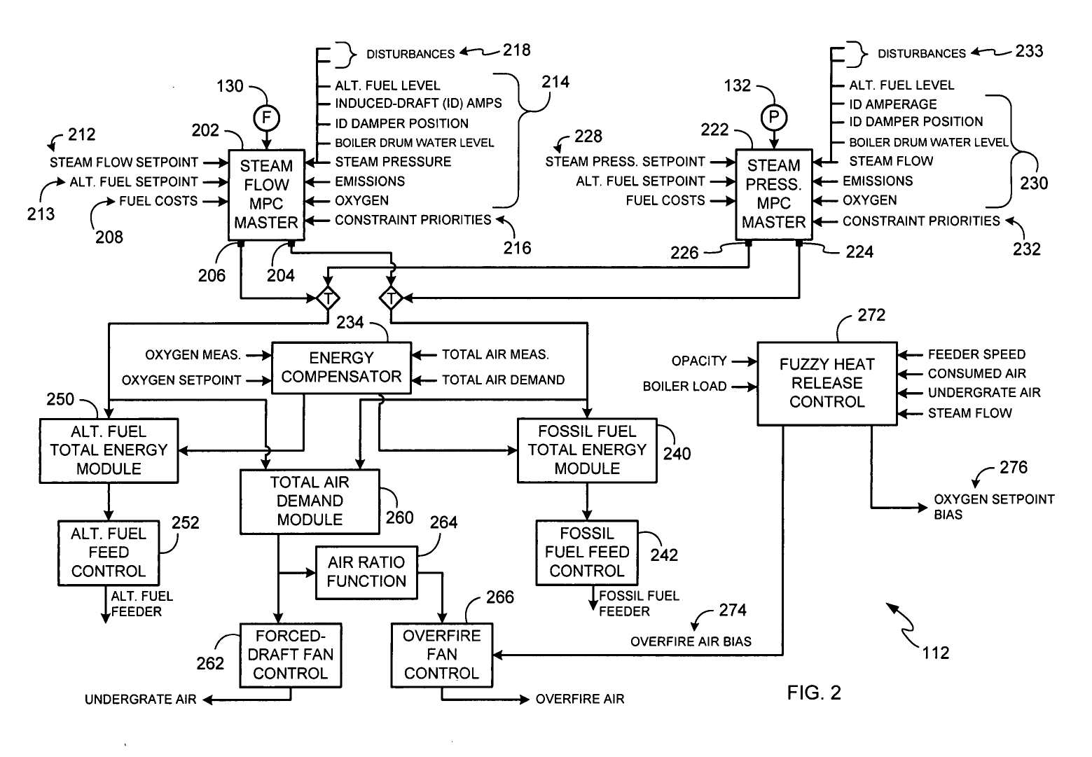

The example steam production system 100 also includes an example control system 112 to acquire and monitor various operating conditions (e.g., energy content of fuel, fuel costs, steam flow, steam pressure, etc.) of the steam production system 100 to determine configuration settings (e.g., fuel supply ratios) that should be used to maintain the steam production output within a predetermined, required or desired operating range (e.g., output a particular amount of steam), while maintaining other operating characteristics (e.g., fuel consumption costs, emissions, steam pressure, etc.) within predetermined, required or desired operating ranges. As described in greater detail below in connection with FIG. 2, the example control system 112 uses model predictive controllers and fuzzy logic to predict configuration settings to substantially reduce or eliminate instances (or the time) during which the example steam production system 100 operates in a non-compliant (and potentially inefficient) condition. In particular, the control system 112 uses measurements of current and/or previous operating conditions to perform analyses to predict how the steam production system 100 may operate in the near or distant future and, based on those analyses, generates configuration settings that are forward-looking to prevent the steam production system 112 from operating outside the predetermined, required or desired operating range(s).

As shown in FIG. 1, the example control system 112 communicates with a water supply valve 114 to control the supply rate or feed rate of water to the boiler 102, a fossil fuel supply valve 116 to control the supply or feed rate of fossil fuel supply to the furnace 106, an alternative fuel supply valve 118 to control the supply or feed rate of alternative fuel to the furnace 106, and an air supply valve 120 to control the supply or feed rate of air to the furnace 106 via an air intake 121. To measure the feed rates or flow rates of each of the supplies (e.g., fuel, water, or air), the control system 112 may be communicatively coupled to a plurality of sensors 122, 124, 126, and 128.

Although the illustrated example of FIG. 1 depicts using the fossil fuel supply valve 116 and the alternative fuel supply valve 118 to control the feed rate of each of the fuels, in other example implementations, the feed rates of either one or both of the fossil fuel and the alternative fuel may be controlled using a conveyor and a conveyor speed control. For example, if the fossil fuel is coal, the coal may be delivered from the fossil fuel reservoir 108 to the furnace 106 using a conveyor system, and the speed of the conveyor system may be controlled using a conveyor speed control to increase or decrease the fossil fuel feed rate. Additionally, if the alternative fuel is waste wood (e.g., tree bark), the waste wood may be delivered from the alternative fuel reservoir 110 to the furnace 106 using a conveyor system and conveyor speed control.

The control system 112 is also communicatively coupled to a steam flow sensor 130 to measure the flow rate of steam supplied by the boiler 102. Of course, in alternative implementations, the steam flow sensor 130 may be placed at any other location such as, for example, a steam supply pipe coupled to a steam header.

The control system 112 is also communicatively coupled to a pressure sensor 132 to measure the steam pressure in the boiler 102. Those of ordinary skill in the art will readily appreciate that in alternative implementations the pressure sensor 132 may be placed at any other location throughout a steam production system other than that shown in FIG. 1 such as, for example, at a steam header or a steam supply pipe.

To measure exhaust emissions produced by the furnace 106, the control system 112 is communicatively coupled to an emission sensor 134 located at an emission exhaust fan 136.

Although not shown, the control system 112 may be communicatively coupled to other sensors (e.g., temperature sensors, flow/feed sensors, pressure sensors, etc.) located throughout the example steam production system 100 to obtain measured values for use in implementing the example systems and methods described herein.

FIG. 2 is a detailed block diagram of the example control system 112 of FIG. 1. The control system 112 may use predictive control techniques to control operation of the example steam production system 100 by determining forward-looking or predicted configuration settings based on present-time monitored conditions. In this manner, the control system 112 can proactively respond to the monitored conditions by changing or adjusting any necessary configuration settings to substantially reduce or prevent the steam production system 100 from operating out of predetermined, desired or required operating conditions (e.g., a steam flow, a steam pressure, fuel consumption cost, etc.). The control system 112 is configured to operate in a steam flow monitoring mode and a steam pressure monitoring mode. For example, the control system 112 may control operation of the steam production system 100 based on monitoring the steam flow measured via, for example, the steam flow sensor 130 (FIG. 1). Alternatively, for example, the control system 112 may control operation of the steam production system 100 based on monitoring the steam pressure measured via, for example, the steam pressure sensor 132 (FIG. 1). Whether the control system 112 operates in a steam flow monitoring mode or a steam pressure monitoring mode may be controlled manually by an operator or automatically based on, for example, a schedule and/or any other criteria.

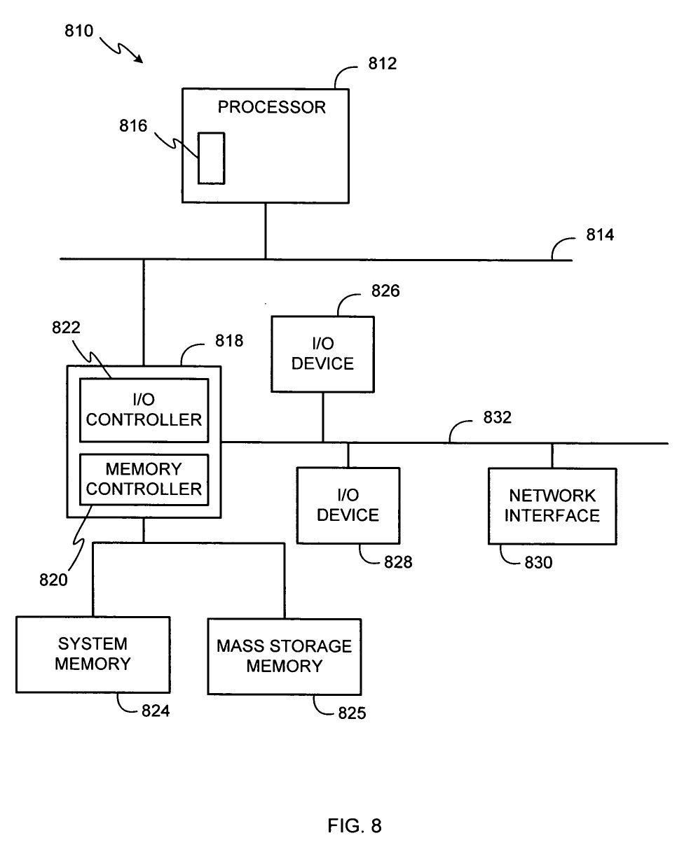

The example structures shown in FIG. 2 depicting the example control system 112 may be implemented using any desired combination of hardware and/or software. For example, one or more integrated circuits, discrete semiconductor components, or passive electronic components may be used. Additionally or alternatively, some or all, or parts thereof, of the example structures of FIG. 2 may be implemented using instructions, code, or other software and/or firmware, etc. stored on a computer-readable medium that, when executed by, for example, a processor system (e.g., the processor system 810 of FIG. 8), perform the methods described herein.

To operate in a steam flow mode, the control system 112 includes a steam flow model predictive controller (MPC) master 202. In an example implementation, the steam flow MPC master 202 may be implemented using an MPC available in the Delta V control system designed and sold by Emerson Process Management, Austin, Tex. The steam flow MPC master 202 is configured to control an amount of steam flow in response to, among other inputs or parameters, steam flow measurements and/or changes in steam flow requirements provided by, for example, an operator. The steam flow MPC master 202 determines two separate outputs associated with setpoints for the alternative fuel feed rate (e.g., the rate at which fossil fuel is supplied to the furnace 106 from the fossil fuel reservoir 108 of FIG. 1) and the fossil fuel feed rate (e.g., the rate at which alternative fuel is supplied to the furnace 106 from the alternative fuel reservoir 110 of FIG. 1).

The steam flow MPC master 202 uses measured steam flow values and a plurality of other input values to determine a predicted trajectory adjustment output value 204 to achieve a specified fossil fuel feed rate and a predicted trajectory adjustment output value 206 to achieve a specified alternative fuel feed rate. The fossil fuel adjustment output value 204 is indicative of a required change (e.g., an increase or decrease) in fossil fuel demand to achieve a particular level of energy (e.g., BTU's) to increase or decrease steam flow. The alternative fuel adjustment output value 206 is indicative of a required change in the alternative fuel supply rate to achieve a particular level of energy. The steam flow MPC master 202 may determine an example predicted trajectory output value based on analyses of historical system condition data and response data. Alternatively or additionally, the example predicted trajectory output value may also be determined using curve-fit techniques or data interpolation techniques. In any case, the example predicted trajectory output values 204 and 206 represent forward looking settings associated with fuel feed rates (e.g., alternative and/or fossil fuel feed rates) that can keep the steam production system 100 operating for a particular or minimum amount of time in the future based on current operating condition values and/or other values obtained by the steam flow MPC master 202.

In the illustrated example, the adjustment output values 204 and 206 work in combination to provide a suitable fossil fuel-to-alternative fuel supply ratio that enables the steam production system 100 to operate within specified operating conditions (e.g., to produce a specified steam flow, operate within steam pressure constraints, operate within cost limits, etc.). When operating in a steam flow control mode, the adjustment output values 204 and 206 are provided to (e.g., cascade) to respective inputs of a fossil fuel total energy module 240 and an alternative fuel total energy module 250 described in greater detail below. Specifically, the fossil fuel adjustment output value 204 is a setpoint value for the fossil fuel total energy module 240 and the alternative fuel adjustment output value 206 is a setpoint value for the alternative fuel total energy module 250.

The steam flow MPC master 202 may be configured to use relatively more alternative lower-cost fuel than fossil fuel to meet economic or budgetary operating conditions. To tune or adjust the fuel type preference (e.g., using relatively more of one type of fuel than another) the steam flow MPC master 202 is provided with a fuel costs input 208 and fuel use preference settings (not shown). In this manner, the steam flow MPC master 202 can adjust use of fuel types as needed in response to changes in fuel prices and based on the fuel use preference settings. An operator may provide particular fuel use preference settings to the steam flow MPC master 202 to configure the steam flow MPC master 202 to use relatively more (e.g., maximize use) or relatively less (e.g., minimize use) of a particular fuel (e.g., one of the fossil fuel or alternative fuel) based on, for example, the fuel costs input 208. For example, the fuel use preference settings may include minimum and/or maximum fuel cost thresholds for each of the fossil fuel and alternative fuel that configure the steam flow MPC master 202 to use relatively more or less of the fuel types when respective fuel costs exceed (e.g., become less than or greater than) respective minimum or maximum fuel cost thresholds. For instance, under some operating conditions, if the cost of fossil fuel provided via the fuel costs input 208 becomes greater than a maximum fossil fuel cost threshold (provided via the fuel use preference settings), the steam flow MPC master 202 can reduce the supply rate of fossil fuel as much as possible whenever possible and increase the supply rate of alternative fuel (e.g., optimize fuel use) until, for example, the cost of fossil fuel falls below the maximum and/or minimum fossil fuel cost threshold.

As shown in FIG. 2, the steam flow MPC master 202 receives steam flow measured values from the steam flow sensor 130 and a steam flow setpoint input value 212 (i.e., a specified or predetermined, desired or required steam flow value). In some example implementations, to substantially reduce or eliminate the effects of pressure and temperature on the steam flow measured values, the steam flow MPC master 202, or some other device or module, may obtain pressure and temperature measurements associated with the boiler 102 to generate temperature and pressure-compensated steam flow values based on the steam flow measured values received from the steam flow sensor 130. The steam flow setpoint input value 212 may be provided by an operator and may be based on the amount of steam required to operate steam-operated sub-systems of, for example, a manufacturing site.

The steam flow MPC master 202 determines the adjustment output values 204 and 206 by determining an error or a deviation between the steam flow measured values and the steam flow setpoint input value 212 and determining the required change in fuel demand (e.g., alternative fuel and/or fossil fuel) to substantially reduce or eliminate the error or deviation. To maintain the steam flow measured values substantially equal to the steam flow setpoint input value, the steam flow MPC master 202 generates the adjustment output values 204 and 206 to cause an increase or decrease in the fuel feed rates. For example, if the energy content of the alternative fuel decreases over time due to, for example, a change in waste wood quality, the furnace 106 may not create sufficient heat to create the required steam flow. In this case, one or both of the adjustment output values 204 and 206 may be increased to increase the amount of fuel delivered to the furnace to cause the boiler 102 to increase the steam flow rate. The steam flow MPC master 202 generates the adjustment output values 204 and 206 in accordance with a fossil fuel-to-alternative fuel feed rate ratio that complies with, for example, the fuel costs input 208, fuel use preference settings (e.g., maximize, minimize, or otherwise optimize use of the fossil fuel or the alternative fuel), and the required energy to produce the required steam flow.

In some example implementations, the steam flow MPC master 202 may be provided with maximum feed rate limits for one or both of the fuel types. For example, as shown in FIG. 2, the steam flow MPC master 202 is provided with an alternative fuel setpoint 213 that indicates the maximum amount or feed rate for the alternative fuel. Under some conditions, the maximum feed rate limits may prevent the steam flow MPC master 202 from maintaining a fossil fuel-to-alternative fuel feed rate ratio that complies with the fuel costs input 208 and fuel use preference settings. For instance, if the energy content of the alternative fuel is not high enough to create the required steam flow even when the alternative fuel feed rate has been set or increased to the maximum limit (i.e., equal to the setpoint 213), the steam flow MPC master 202 will increase the fossil fuel adjustment output value 204 to provide the required energy, regardless of the resulting fossil fuel-to-alternative fuel feed rate ratio.

The steam flow MPC master 202 determines the adjustment output values 204 and 206 at periodic or aperiodic time intervals. In particular, after the steam flow MPC master 202 analyzes its plurality of input values and determines suitable adjustment output values 204 and 206, the steam flow MPC master 202 determines when it should subsequently analyze the input values to determine whether different adjustment output values 204 and 206 should be generated. Specifically, because the control system 112 controls the steam production system in a proactive, predictive, forward-looking manner, the output values or control values (e.g., the adjustment output values 204 and 206) provided by the control system 112 are generated so that the steam production system 100 operates within specified operating conditions for at least a particular or minimum amount of time (t_{f}) in the future. The steam flow MPC master 202 can specify a time that is prior to the expiration of the future time tf at which to again analyze the steam flow measurement.

To prevent operating the steam production system 100 in unstable or undesirable conditions, the steam flow MPC master 202 is also provided with a plurality of constraint values 214. The constraint values 214 are measured variables associated with specified threshold limits that may be provided by, for example, an operator. As the constraint values 214 approach their respective threshold limits, the steam flow MPC master 202 determines adjustment values (e.g., the adjustment output values 204 and 206) to relieve (e.g., increase or decrease) the constraint values 214.

As shown in FIG. 2, the constraint values 214 include an alternative fuel reservoir level, an induced-draft (ID) damper position, an ID fan amperage rating, a boiler drum water level, a measured steam pressure (e.g., a boiler header pressure), an emissions output level, and an oxygen intake. The alternative fuel reservoir level indicates the amount of alternative fuel remaining in the alternative fuel reservoir 110 (FIG. 1). The measured steam pressure may be obtained from the steam pressure sensor 132 (FIG. 1). The emissions output level may be obtained from the emission sensor 134 (FIG. 1). The oxygen intake may be obtained from the air flow sensor 128 (FIG. 1).

Each of the constraint values 214 is associated with one of a plurality of constraint priorities 216. An operator may provide the constraint priorities 216 to prioritize each of the plurality of constraint values 214. Prioritizing the constraint values 214 specifies the order in which the steam flow MPC master 202 considers (or complies) with each of the constraint values 214. For example, an operator may assign first priority (e.g., a highest priority) to the boiler drum water level constraint value to ensure that the steam flow MPC master 202 determines values for the adjustment output values 204 and 206 that will not cause the boiler drum water level to exceed a boiler drum water level constraint threshold. In some cases, to ensure that higher priority constraint values (e.g., the boiler drum water level constraint value) do not violate respective constraint thresholds, the steam flow MPC master 202 may determine values for the adjustment output values 204 and 206 that incidentally or purposely cause lower priority constraint values to violate respective constraint thresholds.

To monitor the effect on steam amounts or quantities demanded by steam-powered machines or sub-systems of a process system that is at least in part powered by the steam produced by the steam production system 100 (FIG. 1), the steam flow MPC master 202 is provided with a plurality of disturbance values 218. The disturbance values 218 may be provided by field devices, field sensor, or field monitors that monitor the operation of sub-systems or machines that use steam produced by the steam production system 100. In this manner, when any sub-system or machine that demands a particular amount of steam shuts down, starts operation, slows operation, increases operation, etc., the steam flow MPC master 202 can predict an increase or decrease in steam demand and determine the adjustment output values 204 and 206 accordingly to ensure that the steam production system 100 increases or decreases steam production to proactively account for any subsequent increase or decrease in steam demand caused by the change in operation of any steam-demanding sub-system or machine. Instead of waiting for steam demand changes to substantially affect operating conditions (e.g., steam pressure) of the steam production system, proactively determining (e.g., predicting) the adjustment output values 204 and 206 to account for any subsequent changes in steam demand based on the disturbance values 218 ensures that the steam demand changes will not substantially affect (e.g., adversely affect) operating conditions of the steam production system 100.

To operate in a steam pressure mode, the control system 112 includes a steam pressure MPC master 222. In an example implementation, the steam pressure MPC master 222 may be implemented using an MPC available in the Delta V control system designed and sold by Emerson Process Management, Austin, Tex. The steam pressure MPC master 222 is configured to control the amount of steam pressure in response to, among other inputs or parameters, steam pressure measurements and/or changes in steam pressure requirements provided by, for example, an operator. The steam pressure MPC master 222 operates to control the amount of steam pressure generated by the boiler 102 (FIG. 1) as the steam flow MPC master 202 operates to control an amount of steam flow as described above. For instance, the steam pressure MPC master 222 determines two separate outputs associated with setpoints for the alternative fuel feed rate and the fossil fuel feed rate. Specifically, the steam pressure MPC master 222 uses measured steam pressure values and a plurality of other input values to determine a predicted trajectory adjustment output value 224 to achieve a specified fossil fuel feed rate and a predicted trajectory adjustment output value 226 to achieve a specified alternative fuel feed rate. The adjustment output values 224 and 226 work in combination to provide a suitable fossil fuel-to-alternative fuel supply ratio that enables the steam production system 100 to operate within specified operating conditions. The control system 112 uses the adjustment output values 224 and 226 in substantially the same manner as described above in connection with the adjustment output values 204 and 206.

A difference between the steam pressure MPC master 222 and the steam flow MPC master 202 described above is that the steam pressure MPC master 222 determines the adjustment output values 224 and 226 by determining an error or deviation between steam pressure measured values received from the pressure sensor 132 (FIGS. 1 and 2) and a steam pressure setpoint input value 228 provided by, for example, an operator.

To prevent operating the steam production process in unstable or undesirable conditions the steam pressure MPC master 222 is also provided with a plurality of constraint values 230, which may be substantially similar or identical to the plurality of constraint values 214 described above in connection with the steam flow MPC master 202. However, because the steam pressure MPC master 222 receives steam pressure measured values from the pressure sensor 132, the steam pressure MPC master 222 is not provided with a separate measured steam pressure constraint value as is the steam flow MPC master 202, but is instead provided with a measured steam flow constraint value as part of the plurality of constraint values 230.

The steam pressure MPC master 222 is also provided with a plurality of constraint priorities 232 that the steam pressure MPC master 222 uses in a manner that is substantially similar or identical to the manner in which the steam flow MPC master 202 uses the plurality of constraint priorities 216 described above. Additionally, the steam pressure MPC master 222 is provided with a plurality of disturbance values 233 that are substantially similar or identical to the plurality of disturbance values 218 described above.

During operation, the control system 112 may be configured to operate in a steam flow mode, a steam pressure mode, or a manual mode. The manual mode may involve an operator controlling fuel feed rates based on steam flow and/or steam pressure. In any case, to enable a bumpless seamless switching between modes, the control system 112 may be configured to track or follow the adjustment output values 204, 206, 224, and 226 with one another and/or with a manual mode fuel feed rate control. For example, to prevent any abrupt changes in operation when, for example, an operator configures the control system 112 to switch from the steam flow mode to the steam pressure mode, each of the adjustment output values 224 and 226 of the steam pressure MPC master 222 is, at least for a period of time at switchover set to track (e.g., is continuously set equal to) a respective one of the adjustment output values 204 and 206 determined by the steam flow MPC master 202.

To prevent abrupt operation changes when the operator switches the control system 112 from steam flow mode to manual mode, manual control fuel feed rate values track (at least for a period of time at the switch over) the adjustment output values 204 and 206 determined by the steam flow MPC master 202. In either case, by tracking the adjustment output values 204 and 206 the control system 112 is substantially prevented from causing any abrupt changes in operation because the fuel feed rates remain the same when the mode changes are made. Similarly, when operating in the steam pressure mode, the adjustment output values 204 and 206 and manual control fuel feed rate values track the adjustment output values 224 and 226. Also, when operating in a manual mode, the adjustment output values 204, 206, 224, and 226 follow respective manual control fuel feed rate values.

To determine energy content variances in, for example, the alternative fuel, the control system 112 is provided with an energy compensator 234 that provides energy compensation values to the fossil fuel control 240 and the alternative fuel control 250 based on calculated variances in energy content of the alternative fuel. The energy compensator 234 may be implemented using a PID controller that responds with reverse control action to a calculated deviation in alternative fuel energy content. The energy compensator 234 performs a relative energy calculation as the quality of the alternative fuel (e.g., the energy content per volume of fuel) changes over time. Specifically, the relative energy calculation determines the energy content of a current batch or supply of alternative fuel relative to a previously monitored or analyzed batch of alternative fuel based on a measured oxygen consumption and a measured air consumption. If the relative energy content of a current batch or supply of alternative fuel is relatively less, then the energy compensation values indicate a required increase in an amount of alternative fuel and/or fossil fuel to maintain delivery or a relatively constant amount of energy to the furnace 106. The energy compensator 234 may increase or decrease the energy compensation values based on, for example, historical data of variances in fuel quality, a fuel-to-energy function curve, and/or a required alternative-to-fossil fuel ratio.

The energy compensator 234 is configured to ensure that the alternative fuel and fossil fuel feed rates are sufficient to maintain a consumed air index of, for example, 100%, regardless of changes in fuel quality (e.g., the energy content per volume of fuel). Maintaining a consumed air index of 100% ensures that 100% of the air drawn or forced into the furnace 106 is combusted by the fuels for a given boiler load (i.e., a given steam production requirement). In this manner, the same amount of energy is burned regardless of changes in fuel quality, thus providing the boiler 102 the required energy (e.g., heat) to produce a required amount of steam (e.g., boiler load). The energy compensator 234 outputs or provides the energy compensation values to the fossil fuel total energy module 240 and the alternative fuel total energy module 250.

To determine the total amount of fossil fuel required to achieve a desired operating condition (e.g., a particular steam pressure, a particular steam flow, a fuel consumption cost, a fuel ratio, etc.), the control system 112 is provided with the fossil fuel total energy module 240. The fossil fuel total energy module 240 receives the fossil fuel adjustment output value 204 (when operating in a steam flow mode) from the steam flow MPC master 202 or the fossil fuel adjustment output value 224 (when operating in a steam pressure mode) from the steam pressure MPC master 222. The fossil fuel total energy module 240 also receives an energy compensation value from the energy compensator 234 and based on the energy compensation value and one of the fossil fuel adjustment output values 204 or 224 determines the total amount of fossil fuel required to produce a required amount of steam flow or steam pressure.

To control the fossil fuel feed rate, the control system 112 is provided with a fossil fuel feed controller 242. The fossil fuel feed controller 242 receives a required fossil fuel amount value from the fossil fuel total energy module 240 and controls, for example, the fossil fuel supply valve 116 to provide fuel at the required feed rate to supply the furnace 106 where the required amount of fossil fuel is determined by the fossil fuel total energy module 240.

To determine the total amount of alternative fuel required to achieve a desired operating condition (e.g., a particular steam pressure, a particular steam flow, a fuel consumption cost, a fuel ratio, etc.), the control system 112 is provided with the alternative fuel total energy module 250. The alternative fuel total energy module 250 receives the alternative fuel adjustment output value 206 (when operating in a steam flow mode) from the steam flow MPC master 202 or the fossil fuel adjustment output value 226 (when operating in a steam pressure mode) from the steam pressure MPC master 222. The alternative fuel total energy module 250 also receives an energy compensation value from the energy compensator 234 and based on the energy compensation value and one of the alternative fuel adjustment output values 206 or 226 determines the total amount of fossil fuel required to produce a required amount of steam flow or steam pressure.

To control the alternative fuel feed rate, the control system 112 is provided with an alternative fuel feed controller 252. The alternative fuel feed controller 252 receives a required alternative fuel amount value from the alternative fuel total energy module 250 and controls, for example, the alternative fuel supply valve 118 to provide the required feed rate to supply the furnace 106 with the required amount of alternative fuel as determined by the alternative fuel total energy module 250.

To control the amount of combustion air provided to the boiler 102 for the alternative and fossil fuels, the control system 112 is provided with an air system that splits the supplied air into undergrate air (i.e., air provided under a fuel-carrying grate) and overfire air (i.e., air provided over the combusting fuel). The air system is configured to determine a total air demand for the alternative fuel and a total air demand for the fossil fuel based on the adjustment output values 204 and 206 from the steam flow MPC master 202 or the adjustment output values 224 and 226 from the steam pressure MPC master 222.

The air system includes a total air demand module 260 that receives the alternative fuel adjustment output value 206 (when operating in a steam flow mode) from the steam flow MPC master 202 or the fossil fuel adjustment output value 226 (when operating in a steam pressure mode) from the steam pressure MPC master 222 and determines the total amount of required boiler airflow, which is the sum of undergrate airflow and overfire airflow. The total air demand module 260 may be implemented using a PID controller to respond to any deviations between measured airflow supply and airflow requirements using reverse control action.

The output of the total air demand module 260 is provided to a forced-draft (FD) fan control 262 and an air ratio function module 264. The forced-draft (FD) fan control 262 controls a FD fan damper to provide the required undergrate airflow to the furnace 106 (FIG. 1) based on the output of the total air demand module 260. The air ratio function module 264 may be implemented using an undergrate air-to-overfire air function curve to determine the required amount of overfire airflow based on the required undergrate airflow. The output of the air ratio function 264 is provided to an overfire fan control 266, which controls an overtire fan damper to supply the required amount of overfire airflow to the furnace 106.

To ensure that supplied overfire airflow supplied by the overfire fan control 266 is sufficient as fuel quality (e.g. energy content per volume of fuel) changes or varies over time, the control system 112 is provided with a fuzzy heat release control 272. The fuzzy heat release control 272 may be implemented using a multivariable fuzzy logic engine including a 5×5 fuzzy matrix that references a steam flow-to-total feeder speed ratio value associated with the alternative fuel (i.e., a steam-feeder ratio), a consumed air ratio (overfire air-to-undergrate air ratio), and a relative-energy controller response (i.e., the output of the energy compensator 234).

The steam-feeder ratio and the consumed air ratio should track one another and, thus, can be used as a check and balance for the fuzzy logic calculation. The fuzzy heat release control 272 monitors the consumed air ratio and the rate of change of the consumed air ratio over, for example, one minute, and generates an overfire air bias value 274 to change the consumed air ratio as necessary. The fuzzy heat release control 272 provides the overfire air bias value 274 to the overfire fan control 266 to change the undergrate air-to-overfire air ratio or split. In addition, the fuzzy heat release control 272 compares the output of the energy compensator 234 with the overtire air bias value 274 to determine whether there are incremental increases in fuel quality (e.g., energy content) without an incremental decrease in overfire air or to determine whether there are incremental decreases in fuel quality without incremental increases in overfire air. If an imbalance exists between the fuel quality and the overfire air, the fuzzy heat release control 272 adjusts the overfire air bias value 274. In this manner, by monitoring the consumed air ratio and the rate of change in the consumed air ratio, and by comparing the output of the energy compensator 234 with the overfire air bias value 274, the fuzzy heat release control 272 can continuously and incrementally adjust the overfire bias value 274 as fuel quality changes over time.

In addition to adjusting the overfire air bias value 274, the fuzzy heat release control 272 can also adjust an oxygen setpoint bias value 276, which causes an increase or decrease in total air delivered to the furnace 106. Typically, the fuzzy heat release control 272 adjusts the oxygen setpoint bias value 276 only when changing the overfire air bias value 274 does not provide a correct undergrate air-to-overfire air ratio for a current fuel quality.

To prevent supplying too much air to the furnace 106 when fuel is no longer entering the furnace 106, the fuzzy heat release control 272 is provided with an enable/disable constraint value (not shown) indicative of the amount of fuel entering the furnace 106.

Each portion (e.g., the steam flow MPC master 202, the steam pressure MPC master 222, the energy compensator 234, the fossil fuel total energy module 240, the fossil fuel feed control 242, the alternative fuel total energy module 250, the alternative fuel feed control 252, the total air demand module 260, the forced-draft fan control 262, the air ratio function 264, the overfire fan control 266, and the fuzzy heat release control 272) of the system controller 112 described above can be operated in an automatic mode or a manual mode. In some example implementations, each of the portions of the system controller 112 can be independently selectable for operation in an automatic or a manual mode.

To enable bumpless or seamless transitioning between automatic and manual operating modes so that the steam production system 100 does not experience abrupt changes in operating conditions, each of the outputs of the portions of the system controller 112 can be tracked between manual mode controls and automatic mode controls. In this manner, when transitioning between each mode, the outputs remain the same until they are changed by an automatic control or an operator via a manual control. For example, when operating in automatic mode, the outputs of each portion of the system controller 112 are tracked or followed by (e.g., set equal to) respective manual mode control values so that any subsequent transition between automatic and manual mode will not cause any abrupt changes in operation of the steam production system 100.

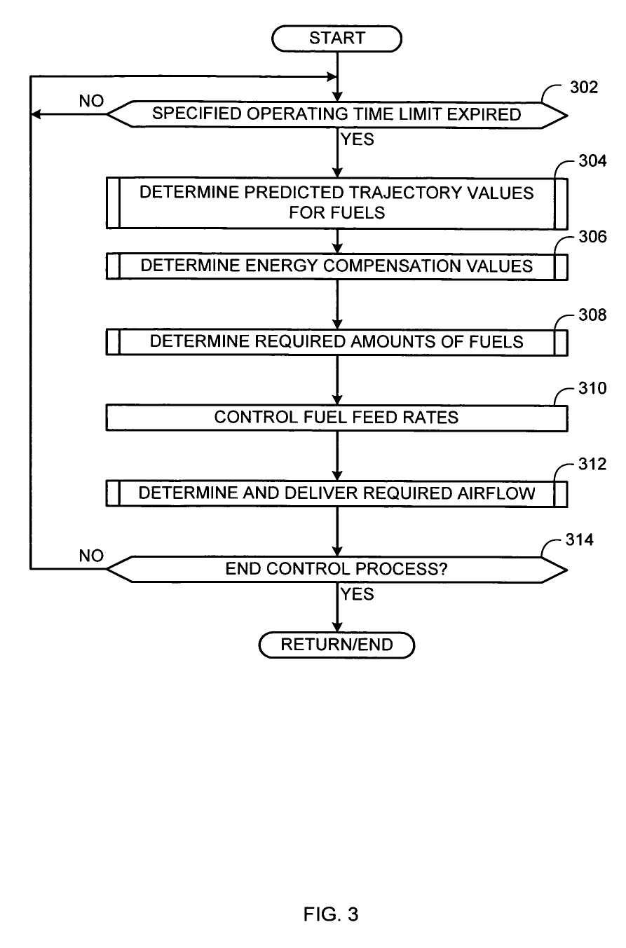

FIGS. 3 through 7 are flow diagrams that depict example methods that may be used to implement the example systems and methods described herein. The example methods depicted in the flow diagrams of FIGS. 3 through 7 may be implemented in software, hardware, and/or any combination thereof. For example, the example methods may be implemented in software that is executed via the control system 112 of FIGS. 1 and 2 and/or the example processor system 810 of FIG. 8. Although, the example methods are described below as a particular sequence of operations, one or more operations may be rearranged, added, and/or eliminated to achieve the same or similar results.

FIG. 3 is a flow diagram that depicts an example method that may be used to control the example steam production system 100 of FIG. 1. The example method of FIG. 3 is described below by way of example as being implemented using the control system 112 described above in connection with FIG. 2. Although the example method of FIG. 3 may be implemented by the control system 112 in an automatic or manual steam flow mode or steam pressure mode, for purposes of clarity, the example method is described with respect to an automatic steam flow mode.

Initially, the steam flow MPC master 202 determines if a specified operating time limit is expired (block 302). The specified operating time limit is specified by the steam flow MPC master 202 after each time that it generates the predicted trajectory adjustment output values 204 and 206 and is associated with the amount of time that the steam production system 100 can operate within operating constraints (e.g., a required amount of steam flow) without requiring updates to the predicted trajectory adjustment output values 204 and 206 to maintain operation within the operating constraints. The operating time limit may be based on a timer or a time of day (e.g., a real-time clock).

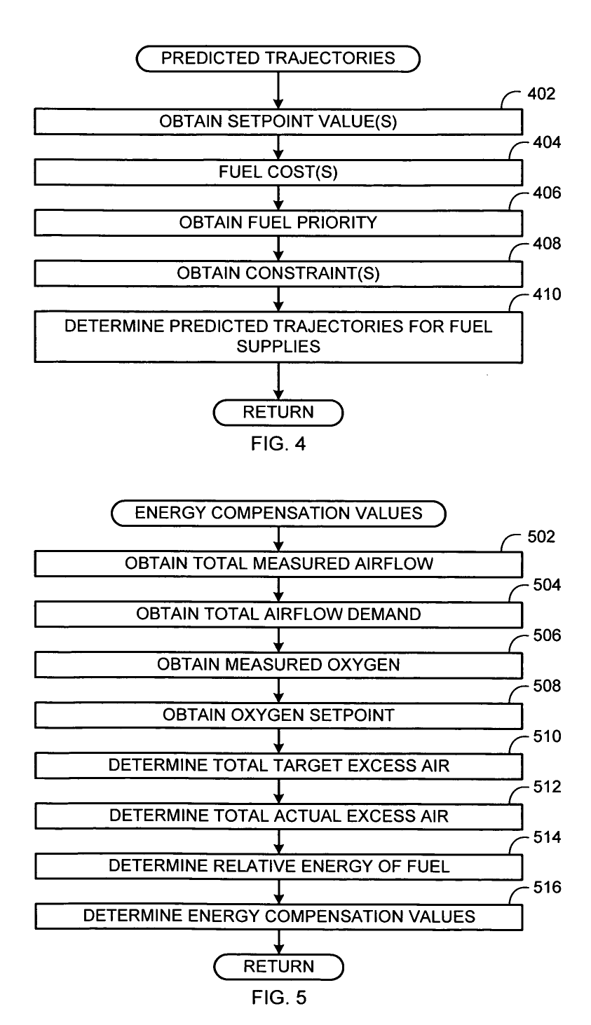

If the steam flow MPC master 202 determines that the operating time limit has not expired, the steam flow MPC master 202 continues to check if the operating time limit has expired (block 302) until the time limit expires or until the control system 112 receives an interrupt or an instruction to do otherwise. If the steam flow MPC master 202 determines at block 302 that the operating time limit has expired, the steam flow MPC master 202 determines the predicted trajectory adjustment output values 204 and 206 (block 304) for the fossil fuel and alternative fuel as described in detail below in connection with the flow diagram of FIG. 4.

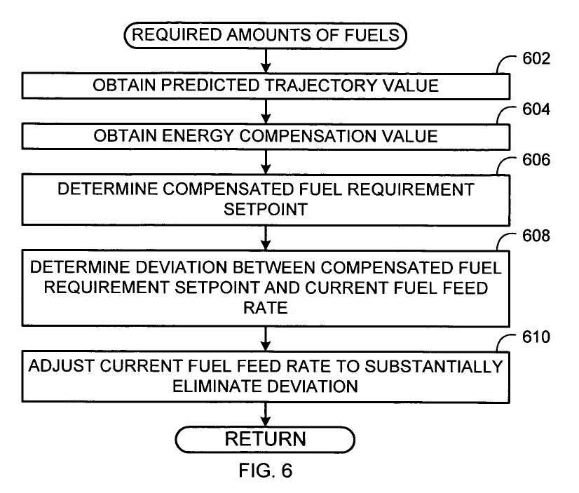

The energy compensator 234 then determines energy compensation values (block 306) associated with the amount of energy (e.g., energy content of the fuel) being delivered to the furnace 106 (FIG. 1) as described in detail below in connection with FIG. 5. The alternative fuel total energy module 250 and the fossil fuel total energy module 260 then determine the required amounts of fuels (block 308) based on the predicted trajectory adjustment output values 204 and 206 received from the steam flow MPC master 202 and the energy compensation values received from the energy compensator 234 as described in detail below in connection with FIG. 6.

The fossil fuel feed controller 242 and the alternative fuel feed controller 252 then control the feed rate of the fossil fuel and the alternative fuel, respectively (block 310). For example, the alternative fuel feed controller 252 may receive an alternative fuel requirement value from the alternative fuel total energy module 250 and generate a fuel feed rate that will cause delivery of the required amount of alternative fuel to the furnace 106 (FIG. 1). The alternative fuel feed controller 252 can then adjust or control the alternative fuel supply valve 118 (FIG. 1) (which may be implemented using a conveyor speed control to control the speed of a waste wood conveyor) based on the generated fuel feed rate value.

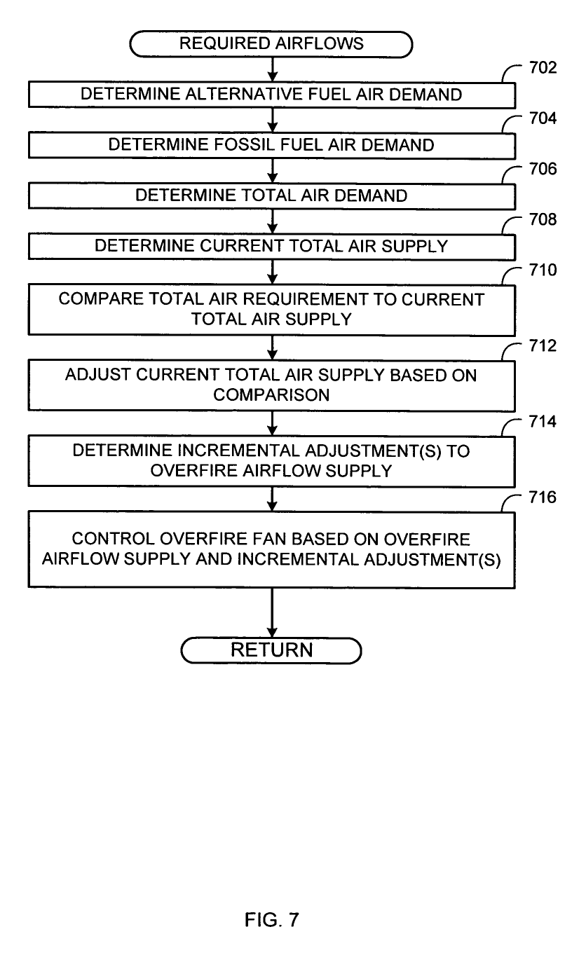

The control system 112 then determines and delivers a required amount of airflow (e.g., undergrate airflow and overfire airflow) (block 312) as described in detail below in connection with FIG. 7.

The control system 112 then determines whether to end the control process (block 314). For example, if an operator or some other control system (e.g., a safety control system) provides the control system 112 with a stop request, the control system 112, in response to the stop request, ends the control process and/or returns control to a calling process or function such as, for example, a shutdown process, an idle process, etc. Otherwise, if the control system 112 determines that it should not end the control process, control is passed back to block 302.

FIG. 4 is a flow diagram depicting an example method that may be used to implement the operation of block 304 of FIG. 3 to determine the predicted trajectory adjustment output values 204 and 206 (FIG. 2). Initially, the steam flow MPC master 202 obtains setpoint values (block 402) associated with determining amounts of required fuels. For example, as shown in FIG. 2, the steam flow MPC master 202 receives the steam flow setpoint 212 and the alternative fuel setpoint 213. The steam flow setpoint 212 specifies a required amount of steam and the alternative fuel setpoint 213 specifies the maximum alternative fuel amount or feed rate.

The steam flow MPC master 202 then obtains one or more of the fuel costs 208 (FIG. 2) (block 404) and fuel use preference settings (e.g., maximize or minimize use of particular fuel based on fuel costs 208) (block 406). For example, the fuel costs 208 may include the cost of the alternative fuel and/or the fossil fuel. The steam flow MPC master 202 uses the costs of the alternative fuel and/or the fossil fuel in combination with the fuel priority to determine a suitable fuel ratio.

The steam flow MPC master 202 then obtains one or more constraint value(s) (block 408) such as, for example, the constraint values 214 (FIG. 2). The steam flow MPC master 202 then uses a model predictive control algorithm to determine the predicted trajectory adjustment output values 204 and 206 for the alternative and fossil fuel supplies (block 410). For example, the steam flow MPC master may use the values obtained at blocks 402, 404, 406, and 408 to determine changes in amounts of fossil and/or alternative fuels to keep the steam production system operating within specified operating conditions to maintain the amount of steam flow indicated by the steam flow setpoint 212. To determine the predicted trajectory adjustment output values 204 and 206, the steam flow MPC master 202 may use one or more of the model prediction algorithms in an MPC available in the Delta V control system designed and sold by Emerson Process Management, Austin, Tex.

In an example implementation, at block 410 the steam flow MPC master 202 may use the fuel costs 208 and fuel use preference settings to determine an economic-based alternative-to-fossil fuel ratio that will keep the steam production system 100 operating within specified operating conditions based on some or all of the values obtained at blocks 402 and 408 (e.g., the steam flow setpoint 212, the alternative fuel setpoint 213, and the constraints 214). In some implementations, the steam flow MPC master 202 may determine the fuel ratio and the predicted trajectory adjustment output values 204 and 206 based on historical data indicating previous similar conditions and corresponding adjustment output values. After the steam flow MPC master 202 determines the predicted trajectory adjustment output values 204 and 206, control is returned to, for example, a calling function or process such as the process of the example method of FIG. 3.

FIG. 5 is a flow diagram of an example method that may be used to implement the operation of block 306 of FIG. 3 to determine energy compensation values (via the energy compensator 234 (FIG. 2)) associated with adjusting fuel feed rates in response to varying energy contents in the alternative fuel. Initially, the energy compensator 234 obtains a total measured airflow (block 502) indicative of the total air intake into the furnace 106 (FIG. 1). The energy compensator 234 then obtains a total air demand (block 504). The total air demand (or total air requirement) may be provided by an operator or by the total air demand module 260 and is associated with the total amount of air that should be provided to the furnace 160.

The energy compensator 234 then obtains a measured oxygen value (block 506). For example, the energy compensator 234 may receive the measured oxygen value from an oxygen sensor (not shown) that may be located at the air intake 121 (FIG. 1). The energy compensator 234 then obtains an oxygen setpoint (506) provided by, for example, an operator, or the constraint values 214 and/or from an oxygen setpoint bias provided by the fuzzy heat release control 272 (FIG. 2).

The energy compensator 234 then determines a percentage of total target excess air (block 510) by, for example, subtracting the oxygen setpoint value obtained at block 508 from the total air demand value obtained at block 504. The total target excess air is the target amount of air that will not be combusted in the furnace 106. The energy compensator 234 then determines a total actual excess air (block 512) by, for example, subtracting the measured oxygen value obtained at block 506 from the total measured air value obtained at block 502.

The energy compensator 234 then determines a relative energy of fuel value (block 514) using, for example, Equation 1 shown below.

$$ENERGY ( BTU ) = ( \frac{TAF}{TAD} \times 100 ) + ( TEA - AEA ) \qquad Equation 1$$

The energy compensator 234 uses Equation 1 above to determine a relative energy of fuel in BTU's (e.g., ENERGY(BTU)). As shown in Equation 1, the energy compensator 234 determines the relative energy by dividing total measured airflow (TAF) obtained at block 502 by the total air flow demand (TAD) obtained at block 504 to produce a quotient (TAF/TAD). The total measured airflow (TAF) and the total air flow demand (TAD) may be provided as values measured in kilopounds per hour (kpph). The energy compensator 234 then multiplies the quotient (TAF/TAD) by a unit conversion “100” to generate a product

$$( \frac{TAF}{TAD} \times 100 ) .$$

The energy compensator 234 then subtracts the actual excess air (AEA) determined at block 512 from the target excess air (TEA) determined at block 510 to generate the subtraction result (TEA−AEA). The actual excess air (AEA) and the target excess air (TEA) may be provided as excess air percentage values. The energy compensator 234 then determines the relative energy of the fuel by adding the product

$$( \frac{TAF}{TAD} \times 100 )$$

and the subtracting result (TEA−AEA).

After the energy compensator 234 determines a relative energy value at block 514, the energy compensator 234 determines energy compensation values (block 516) based on the relative energy value. For instance, the relative energy value determined at block 514 is indicative of fuel quality changes in, for example, the alternative fuel over time. If the alternative fuel feed rate remains relatively constant over time, but the energy content of the alternative fuel decreases, the relative energy value will be indicative of the energy content decrease. Accordingly, the energy compensator 234 may generate energy compensation values based on the energy content decrease as indicated by the relative energy value to cause the alternative fuel total energy module 250 and/or the fossil fuel energy module 240 to increase respective fuel feed rates to compensate for the decrease in alternative fuel quality. In some example implementations, the energy compensator 234 may generate energy compensation values that cause the total fuel energy modules 240 and 250 to increase or decrease respective fuel amounts differently based on specified fuel ratios determined by an operator or the steam flow MPC master 202 according to the fuel costs 208 and fuel use preference settings. The energy compensator 234 may also generate the energy compensation values based on the alternative fuel setpoint 213 (FIG. 2), which defines the maximum allowable amount of alternative fuel. After the energy compensator 234 determines the energy compensation values at block 516, control is returned to, for example, a calling process or function such as the example process described above in connection with FIG. 3.

FIG. 6 is a flow diagram of an example method that may be used to implement the operation of block 308 of FIG. 3 to determine required amounts of fuel to operate the example steam production system 100 of FIG. 1 within specified operating conditions. Although the example method of FIG. 6 is described by way of example in connection with the alternative fuel total energy module 250 (FIG. 2) the example method of FIG. 6 may also be used in connection with the fossil fuel total energy module 240 in a substantially similar or identical manner to that described below. Initially, the alternative fuel total energy module 250 obtains the predicted trajectory adjustment output value 206 from the steam flow MPC master 202 (FIG. 2) (block 602) and an energy compensation value from the energy compensator 234 (FIG. 2) (block 604). For example, the alternative fuel total energy module 250 may obtain the predicted trajectory adjustment output value 206 determined at block 410 of FIG. 4 and an energy compensation value determined at block 516 of FIG. 5.

The alternative fuel total energy module 250 then determines a compensated fuel requirement set point (block 606) based on the predicted trajectory adjustment output value 206 obtained at block 602 and the energy compensation value obtained at block 604. For example, if the energy compensation value indicates that the fuel quality (e.g., energy content) of the alternative fuel has decreased, then the alternative fuel total energy module 250 determines a compensated fuel requirement setpoint to increase the alternative fuel feed rate to compensate for the decreased fuel quality.

The alternative fuel total energy module 250 then determines a deviation between the compensated fuel requirement setpoint and a current fuel feed rate (block 608). The alternative fuel feed controller 252 then adjusts the current fuel feed rate to substantially eliminate the deviation (block 610) determined at block 608 by the alternative fuel total energy module 250. In some example implementations, the alternative fuel feed controller 252 can incrementally or gradually increase or decrease the fuel feed rate over time until the energy compensated values, which may be continually generated by the energy compensator 234, indicate a zero change or no change in fuel quality. After adjusting the fuel feed rates, control is returned to, for example, a calling function or process such as the example process of FIG. 3.

FIG. 7 is a flow diagram of an example method that may be used to implement the operation of block 312 of FIG. 3 to determine and control the required airflows of the example steam production system 100 of FIG. 1. Initially the total air demand module 260 determines the alternative fuel air demand (or requirement) (block 702) using, for example, Equations 2 and 3 below.

$$\begin{matrix}AAD = SADa \times ( 1 + \frac{TEA}{100} ) , \\ where & Equation 2 \\ SADa = AFD \times \frac{A}{Fa} & Equation 3\end{matrix}$$

As shown above in Equation 2, the total air demand module 260 determines an alternative fuel air demand (AAD) by dividing the target excess air (TEA) determined at block 510 of FIG. 5 by one hundred (100) to produce a quotient value (TEA/100). The target excess air (TEA) may be provided as a percentage of target excess air. The total air demand module 260 then adds one to the quotient value (TEA/100) to produce a sum value

$$( 1 + \frac{TEA}{100} ) .$$

The total air demand module 260 then multiplies the sum value

$$( 1 + \frac{TEA}{100} )$$

by stoichiometric air demand for the alternative fuel (SADa) to determine the alternative fuel air demand (AAD). The stoichiometric air demand for the alternative fuel (SADa) may be provided in kpph units and may be determined according to Equation 3.

As shown above in Equation 3, the total air demand module 260 determines the stoichiometric air demand for the alternative fuel (SADa) by multiplying an alternative fuel feed demand (AFD) by an air-to-fuel ratio for the alternative fuel (A/Fa). The alternative fuel feed demand (AFD) may be provided as a percentage value indicative of percentage of alternative fuel demand (e.g., the required amount of alternative fuel as determined by the alternative fuel total energy module 250 of FIG. 2) included in a total fuel demand including alternative fuel and fossil fuel demands. The air-to-fuel ratio for the alternative fuel (A/Fa) may be provided as a percentage of required air per unit of demanded alternative fuel.

The total air demand module 260 then determines a fossil fuel air demand (FAD) (block 704) using, for example, Equations 4 and 5 below.

$$\begin{matrix}FAD = SADf \times ( 1 + \frac{TEA}{100} ) , \\ where & Equation 4 \\ SADf = FFD \times \frac{A}{Ff} & Equation 5\end{matrix}$$

As shown above in Equations 4 and 5, the total air demand module 260 determines the fossil fuel air demand (FAD) in a manner substantially similar to that described above in connection with Equations 2 and 3. One difference between Equations 4 and 2 is that the fossil fuel air demand (FAD) is determined based on the stoichiometric air demand for fossil fuel (SADf) instead of the stoichiometric air demand for alternative fuel (SADa). Notable differences between Equations 5 and 3 are that the stoichiometric air demand for fossil fuel (SADf) is determined based on a fossil fuel feed demand (FFD) instead of the alternative fuel feed demand (AFD) and based on an air-to-fuel ratio for the fossil fuel (A/Ff) instead of the air-to-fuel ratio for the alternative fuel (A/Fa).

The total air demand module 260 then determines the total air demand (block 706) by, for example, adding the alternative fuel air demand (AAD) determined at block 702 to the fossil fuel air demand (FAD) determined at block 704. The total air demand module 206 then determines the current total air supply (block 708). For example, the total air demand module 260 may determine the current total air supply by receiving airflow measurements from a furnace air intake airflow sensor (e.g., the airflow sensor 128 of FIG. 1). Alternatively, the total air demand module 260 may obtain and sum a measured overtire airflow value and a measured undergrate airflow value. In some example implementations, the total air demand module 260 may perform calculations based on the received measured overfire and undergrate airflow values to generate an air temperature and/or air pressure compensated current total air supply value.

The total air demand module 260 then compares the total air demand determined at block 706 to the current total air supply determined at block 708 (block 710) and causes the forced-draft fan control 262 and the overfire fan control 266 to adjust the current total air supply based on the comparison (block 712). For example, the total air demand module 260 may adjust the current total air supply using reverse control action in connection with proportional and integral tuning constants to substantially minimize or eliminate the deviation between the total air demand determined at block 706 and the current total air supply determined at block 708. Also, in the illustrated example of FIG. 2, the amount of overfire airflow is based on the amount of undergrate airflow. Specifically, the amount of undergrate airflow determined by the total air demand module 260 is communicated to the forced-draft fan control 262 to control the amount of undergrate airflow and to an air ratio function 264 to determine an amount of overfire airflow. The air ratio function 264 may be a curve or function that causes the overfire airflow to be determined based on the undergrate airflow. In some example implementations, the air ratio function 264 is substantially fixed during operation of the example steam production system 100 (FIG. 1).

In some example implementations, because of the changing or varying fuel quality (e.g., energy content per volume of fuel) of, for example, the alternative fuel, the furnace 106 (FIG. 1) may require adjustments to the amount of overfire airflow supply. That is, the air ratio function 264 may generate relatively less efficient overfire airflow supply values as fuel quality varies over time. To adjust the overfire airflow to ensure that the steam production system 100 operates within specified operating conditions (e.g., steam flow conditions, steam pressure conditions, economical conditions, etc.), the fuzzy heat release control 272 determines incremental adjustments to the overfire airflow supply (block 714). For example, the fuzzy heat release control 272 may determine the incremental adjustments as described above in connection with FIG. 2 using, for example, a 5×5 fuzzy matrix that references a steam flow-to-total feeder speed ratio value associated with the alternative fuel (i.e., a steam-feeder ratio), a consumed air ratio (overfire air-to-undergrate air ratio), and the energy compensation values generated by the energy compensator 234.

The overfire fan control 266 then controls the overfire fan based on the overfire airflow supply values determined by the air ratio function 264 and the incremental adjustment values determined by the fuzzy heat release control 272 (block 716). Control is then returned to, for example, a calling function or process such as the example process of FIG. 3.

FIG. 8 is a block diagram of an example processor system that may be used to implement the example apparatus, methods, and articles of manufacture described herein. As shown in FIG. 8, the processor system 810 includes a processor 812 that is coupled to an interconnection bus 814. The processor 812 includes a register set or register space 816, which is depicted in FIG. 8 as being entirely on-chip, but which could alternatively be located entirely or partially off-chip and directly coupled to the processor 812 via dedicated electrical connections and/or via the interconnection bus 814. The processor 812 may be any suitable processor, processing unit or microprocessor. Although not shown in FIG. 8, the system 810 may be a multi-processor system and, thus, may include one or more additional processors that are identical or similar to the processor 812 and that are communicatively coupled to the interconnection bus 814.

The processor 812 of FIG. 8 is coupled to a chipset 818, which includes a memory controller 820 and an input/output (I/O) controller 822. As is well known, a chipset typically provides I/O and memory management functions as well as a plurality of general purpose and/or special purpose registers, timers, etc. that are accessible or used by one or more processors coupled to the chipset 818. The memory controller 820 performs functions that enable the processor 812 (or processors if there are multiple processors) to access a system memory 824 and a mass storage memory 825.

The system memory 824 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc.

The I/O controller 822 performs functions that enable the processor 812 to communicate with peripheral input/output (I/O) devices 826 and 828 and a network interface 830 via an I/O bus 832. The I/O devices 826 and 828 may be any desired type of I/O device such as, for example, a keyboard, a video display or monitor, a mouse, etc. The network interface 830 may be, for example, an Ethernet device, an asynchronous transfer mode (ATM) device, an 802.11 device, a DSL modem, a cable modem, a cellular modem, etc. that enables the processor system 810 to communicate with another processor system.

While the memory controller 820 and the I/O controller 822 are depicted in FIG. 8 as separate functional blocks within the chipset 818, the functions performed by these blocks may be integrated within a single semiconductor circuit or may be implemented using two or more separate integrated circuits.

Although certain systems, methods, and articles of manufacture have been described herein, the scope of coverage of this patent is not limited thereto. To the contrary, this patent covers all systems, methods, and articles of manufacture fairly falling within the scope of the appended claims either literally or under the doctrine of equivalents.

What is claimed is:

1. A method of controlling a multiple-fuel steam production system, comprising:
obtaining a plurality of input values associated with producing steam;
using a model predictive controller to determine a first value associated with predicting an amount of first fuel to produce an amount of steam;
using the model predictive controller to determine a second value associated with predicting an amount of second fuel to produce the amount of steam; and
controlling fuel feed rates of the first and second fuels based on the first and second values.

2. A method as defined in claim 1, wherein the first and second values are trajectory values.

3. A method as defined in claim 1, wherein the first and second values are associated with producing the amount of steam for a predetermined amount of time.

4. A method as defined in claim 3, wherein controlling the fuel feed rates of the first and second fuels based on the first and second values comprises controlling the fuel feed rates of the first and second fuels for the predetermined amount of time based on the first and second values.

5. A method as defined in claim 4, further comprising using the model predictive controller to determine the predetermined time duration.

6. A method as defined in claim 1, wherein the plurality of input values include at least one of a steam flow setpoint value or a steam pressure setpoint value.

7. A method as defined in claim 1, wherein the plurality of input values includes a fuel cost value associated with at least one of the first fuel or the second fuel.

8. A method as defined in claim 1, wherein the first fuel is a fossil fuel and the second fuel is at least one of waste wood or shredded tires.

9. A method as defined in claim 1, wherein the model predictive controller determines the first value and the second value to achieve a specified fuel ratio.

10. A method as defined in claim 1, wherein at least one of the plurality of input values is indicative of the energy content of at least one of the first fuel or the second fuel.

11. A method as defined in claim 1, further comprising determining a compensation value associated with adjusting at least one of the fuel feed rates based on a varying energy content in at least one of the first fuel or the second fuel.

12. A method as defined in claim 1, further comprising determining an amount of airflow to produce the amount of steam based on at least one of a first fuel airflow demand or a second fuel airflow demand.

13. A method as defined in claim 12, further comprising using a fuzzy logic controller to adjust the amount of airflow based on an energy content of at least one of the first fuel or the second fuel.

14. A method as defined in claim 1, wherein the model predictive controller determines the first and second values based on a steam flow operating condition, and further comprising switching control between the model predictive controller and another model predictive controller to determine a third value associated with predicting another amount of the first fuel and a fourth value associated with predicting another amount of the second fuel to produce the amount of steam based on a steam pressure operating condition.

15. A system to control a multiple-fuel steam production system, comprising:
a model predictive controller to determine a first value associated with predicting an amount of a first fuel and a second value associated with predicting an amount of a second fuel to produce an amount of steam; and
first and second fuels feeder controls to control fuel feed rates of the first and second fuels based on the first and second values.

16. A system as defined in claim 15, wherein the first and second values are trajectory values.

17. A system as defined in claim 15, wherein the first and second values are associated with producing the amount of steam for a predetermined time duration.

18. A system as defined in claim 17, wherein the first and second fuel feeder controls control the fuel feed rates of the first and second fuels for the predetermined time duration based on the first and second values.

19. A system as defined in claim 17, wherein the model predictive controller determines the predetermined time duration.

20. A system as defined in claim 15, wherein the model predictive controller determines the first and second values based on at least one of a steam flow setpoint value or a steam pressure setpoint value.

21. A system as defined in claim 15, wherein the model predictive controller determines the first and second values based on a fuel cost value associated with at least one of the first fuel or the second fuel.

22. A system as defined in claim 15, wherein the first fuel is a fossil fuel and the second fuel is at least one of waste wood or shredded tires.

23. A system as defined in claim 15, wherein the model predictive controller determines the first and second values to achieve a specified fuel ratio.

24. A system as defined in claim 15, wherein the model predictive controller determines the first and second values based on an energy content of at least one of the first fuel or the second fuel.

25. A system as defined in claim 15, further comprising an energy compensator to determine a compensation value associated with adjusting at least one of the fuel feed rates based on a varying energy content in at least one of the first fuel or the second fuel.

26. A system as defined in claim 15, further comprising an airflow module to determine an amount of airflow to produce the amount of steam based on at least one of a first fuel airflow demand or a second fuel airflow demand.

27. A system as defined in claim 26, further comprising a fuzzy logic controller to adjust the amount of airflow based on an energy content of at least one of the first fuel or the second fuel.

28. A system as defined in claim 15, wherein the model predictive controller determines the first and second values based on a steam flow operating condition, and further comprising another model predictive controller to determine a third value associated with predicting another amount of the first fuel and a fourth value associated with predicting another amount of the second fuel to produce the amount of steam based on a steam pressure operating condition.

29. A machine accessible medium having instructions stored thereon that, when executed, cause a machine to:
determine a first value associated with predicting an amount of a first fuel to produce an amount of steam;
determine a second value associated with predicting an amount of a second fuel to produce the amount of steam; and
control fuel feed rates of the first and second fuels based on the first and second values.

30. A machine accessible medium as defined in claim 29, wherein the first and second values are trajectory values.

31. A machine accessible medium as defined in claim 29 having the instructions stored thereon that, when executed, cause the machine to determine the first and second values to produce the amount of steam for a predetermined time duration.

32. A machine accessible medium as defined in claim 31 having the instructions stored thereon that, when executed, cause the machine to control fuel feed rates of the first and second fuels for the predetermined time duration based on the first and second values

33. A machine accessible medium as defined in claim 31 having the instructions stored thereon that, when executed, cause the machine to determine the predetermined time duration.

34. A machine accessible medium as defined in claim 29 having the instructions stored thereon that, when executed, cause the machine to determine the first and second values based on at least one of a steam flow setpoint value or a steam pressure setpoint value.

35. A machine accessible medium as defined in claim 29 having the instructions stored thereon that, when executed, cause the machine to determine the first and second values based on a fuel cost value associated with at least one of the first fuel or the second fuel.

36. A machine accessible medium as defined in claim 29, wherein the first fuel is a fossil fuel and the second fuel is at least one of waste wood or shredded tires.

37. A machine accessible medium as defined in claim 29 having the instructions stored thereon that, when executed, cause the machine to determine the first and second values to achieve a specified fuel ratio.

38. A machine accessible medium as defined in claim 29 having the instructions stored thereon that, when executed, cause the machine to determine the first and second values based on an energy content of at least one of the first fuel or the second fuel.

39. A machine accessible medium as defined in claim 29 having the instructions stored thereon that, when executed, cause the machine to determine a compensation value associated with adjusting at least one of the fuel feed rates based on a varying energy content in at least one of the first fuel or the second fuel.

40. A machine accessible medium as defined in claim 29 having the instructions stored thereon that, when executed, cause the machine to determine an amount of airflow to produce the amount of steam based on at least one of a first fuel airflow demand or a second fuel airflow demand.

41. A machine accessible medium as defined in claim 40 having the instructions stored thereon that, when executed, cause the machine to use fuzzy logic to adjust the amount of airflow based on an energy content of at least one of the first fuel or the second fuel.

42. A machine accessible medium as defined in claim 29 having the instructions stored thereon that, when executed, cause the machine to
determine the first and second values via a first model predictive controller based on a steam flow operating condition; and
switch control between the first model predictive controller and a second model predictive controller to determine a third value associated with predicting another amount of the first fuel and a fourth value associated with predicting another amount of the second fuel to produce the amount of steam based on a steam pressure operating condition.
